(19) United States
(12) Patent Application Publication
(10) Pub. No.: US 2008/0205804 A1
(43) Pub. Date: Aug. 28, 2008

(54) Simplified Fluid Dynamic Bearing Design

(76) Inventor: Jian-Dih Jeng, Linkou Township (TW)

Correspondence Address: HDSL, 4331 STEVENS BATTLE LANE, FAIRFAX, VA, 22033, US

(21) Appl. No.: 12/037,913

(22) Filed: Feb. 26, 2008

(30) Foreign Application Priority Data
Feb. 27, 2007 (TW) 096106650

(51) Int. Cl. F16C 32/06

(52) U.S. Cl. 384/123

(57) ABSTRACT

The invention is related to a fluid dynamic bearing design, wherein inner wall of bearing or surface of shaft is made with inner grooves having self-lubricating functions to effect radial pressure waves according to stable bearing operating requirements as well as working and assembly methods. Embodiments of said inner grooves include seal, open and re-circulation types, wherein seal type inner grooves reduces overflow of lubricants, while open type rifling grooves and re-circulation type grooves allows for recirculation of lubricating fluid to promote rotational stability of the shaft.

### BACKGROUND OF THE INVENTION

(a) Field of the Invention

The invention is related to a fluid dynamic bearing design, wherein the inner wall of bearing or surface of a shaft is made with inner grooves having self-lubricating functions to effect radial pressure waves according to stable bearing operating requirements as well as working and assembly methods. Embodiments of the inner grooves include seal, open and re-circulation types, wherein the seal type inner grooves reduces lubricants overflow, while open type rifling grooves and re-circulation type grooves allows for recirculation of lubricating fluid to promote rotational stability of the shaft.

(b) Description of the Prior Art

The known fluid dynamic bearing design in general, in considering the requirements for low friction and low oil leakage at high rotating speed, inner wall of bearing or shaft is cut with inner grooves, wherein the groove depth is cut to around 3-10 micrometers (μm), whereby when the shaft is rotated at high speed, fluid inside the grooves are then effected to produce radially protruded pressure waves, while the pressure waves at a circle all point to center of spindle thereby to provide a fluid power source for stabilizing bearing rotation.

For seal type grooves embodiment, the tail ends of grooves in maximum height are made shorter than the front and rear end faces of bearing in axial direction so as to seal lubricating fluid inside the bearing. Nonetheless, the inner grooves on inner surface of bearing is more difficult to work on and it is more time consuming, therefore known inner grooves working usually makes tail ends of grooves in maximum height to align with the two front and rear end faces of bearing, whereas the working method is easier, it is disadvantageous in that the lubricating oil grease is easy to leak out of bearing thus causing drops in bearing life and quality.

### SUMMARY OF THE INVENTION

In considering the required lubricity and conditions of stability as well as convenience of working method, the invented fluid dynamic bearing groove design is functionally divided to include seal, re-circulation and open type grooves, applicable for liquid or gaseous lubricants.

Based on requirements in bearing lubricity and stable operation, the design is mainly focused on the following to promote bearing rotational stability:

(1) To reduce bearing friction and increase shaft stability by making inner grooves on the central shaft surface or on the inner surface of bearing to produce radically protruded pressure wave.

(2) Seal type inner grooves are best for oil grease lubricants to avoid oil grease leakage or sucking air improperly to produce air bubbles in the grease lubricants whereby to lower down operating efficiency.

(3) When gas is the lubricant, the inner grooves design is further made with a regulated streamline design in helical or rifling shape to increase the inner pressure of bearing so as to achieve a high rotational speed balancing function similar to a bullet in a shot gun.

(4) A simple anti-breakaway lock is made to avoid sudden breakaway of shaft by an external force.

### BRIEF DESCRIPTION OF THE DRAWINGS

FIG. 1 is a schematic view of the invention showing a sealed bearing groove design.

FIG. 2 is a schematic view of an invented groove embodiment design.

FIG. 3 is a schematic view of another invented groove embodiment design.

FIG. 4 is a schematic view of another invented groove embodiment design.

FIG. 5 is a schematic view of another invented groove embodiment design.

FIG. 6 is a schematic view of the invention showing an integrally formed bearing design.

FIG. 7 is a schematic view of the invention showing a groove embodiment and a lubricating fluid circulation.

FIG. 8 is another schematic view of the invention showing a groove embodiment and a lubricating fluid circulation.

FIG. 9 is a schematic view of an invented open type bearing grooves design.

FIG. 10 is a schematic view of an invented recirculation type bearing grooves design.

FIG. 11 is a spread-out view of the invented recirculation type bearing grooves.

### DETAILED DESCRIPTION OF THE PREFERRED EMBODIMENTS

The contents and produced effectiveness of the invented simplified fluid dynamic bearing design is described by the preferred embodiments with the accompanying Figs. in detail as the following:

Fluid dynamic bearing is considered better than ball bearing since it has almost no rotational frictions between its shaft and bearing and low noise, wherein lubrication for fluid dynamic bearing requires not only a precise control on the clearance between shaft and bearing, but also the pre-grooved contact surfaces allowing liquid or gaseous lubricating fluid to generate a radial pressure wave for self-lubrication, and to constantly correct shaft during the rotating process thereby to achieve the stable rotation purpose.

Oil grease type liquid lubricants are normally used in ordinary fluid dynamic bearings for their better lubricity, but are disadvantageous in that oil grease is easy to leak or is easy to loose by evaporation causing bearing quality to drop. If gas (air) is used as the lubricant, the oil grease evaporation problems can be avoided, further, surface of shaft and inner surface of bearing can be sprayed with a protective coating of material such as Molybdenum disulphide or Boron nitride, or which can be mixed in the base material thereof to reduce wearing, however it is disadvantageous to have a poorer lubrication effect than the one of oil grease. No matter liquid or gas type lubricants are adopted, inner grooves are still needed on the surface of shaft and inner surface of bearing for benefiting fluid circulation. The invention has concluded three kinds of groove embodiments and application which are separately described in the following:

(1) Seal Type Grooves

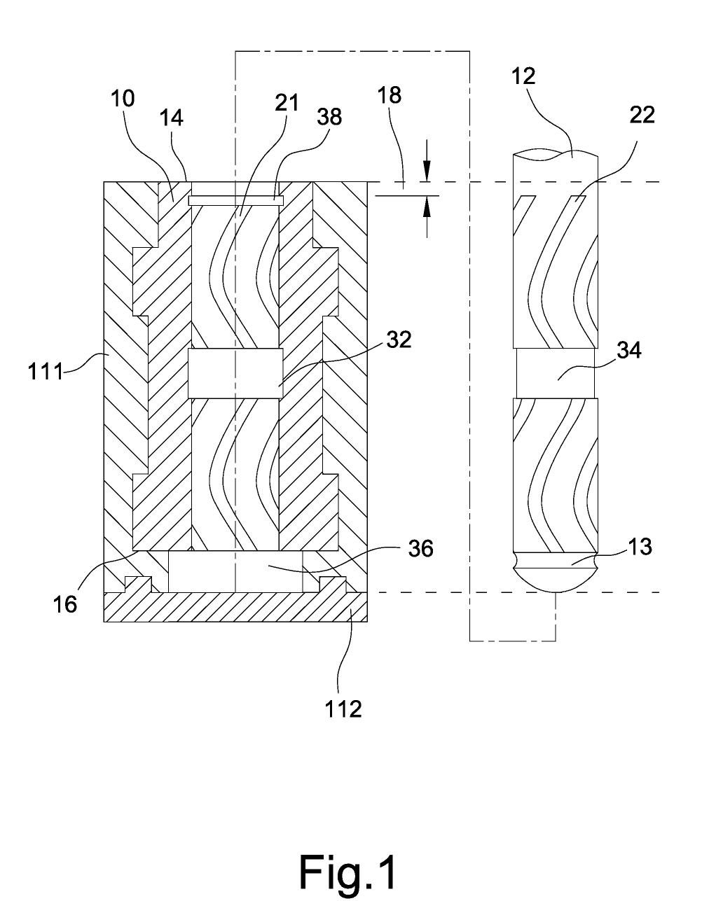

Referring to FIG. 1, by cutting inner grooves 21 on inner surface of bearing 10 or cutting inner grooves 22 on the surface of shaft 12, the lubricating fluid inside the grooves is extruded by friction or inertia forces to form a radially protruded pressure wave at a certain section along the curve route of groove during rotating process, thereby to stabilize the shaft and to control its clearance to the bearing. Lubricating fluid is stored in the first space 32, second space 34 or third space 36 for complementing insufficiencies in the grooves.

To avoid loosing lubricating fluid, sealing clearance 18 between tail end edge of grooves 21, 22 and first end face 14 shall be at least greater than zero. Another tail end edge of the groove is connected with the second end face 16 of bearing to allow the groove to connect with the lubricating fluid storing space, whereby lubricating fluid inside the space can be flowed out smoothly while the groove is not connected to the outside, so that lubricating fluid is not easily lost. As a whole, lubricating fluid is circulated in a closed loop inside the bearing, wherein the bearing and shaft are made of metal or plastic material or made of a combination of the two.

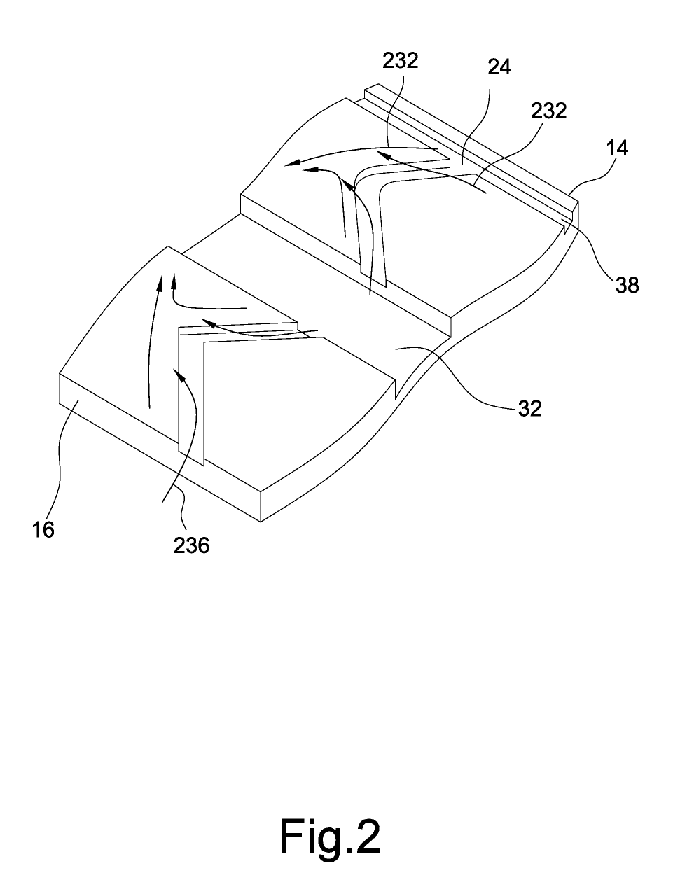

Referring to FIG. 2 for the result of lubricating fluid flow analysis, the rotational flow field between bearing and shaft includes circle tangent flow lines 232 formed in a plurality of linear grooves 24 and internal circulating flows 236 for lubricating fluid complement, wherein form design of the linear grooves can be a plurality of circular arc shapes or sawtooth shapes. The linear grooves can be mutually connected with lubricating fluid storing spaces 32, 38 but without connecting to the outside, wherein the tail end of the groove is kept at a distance from the end face of bearing.

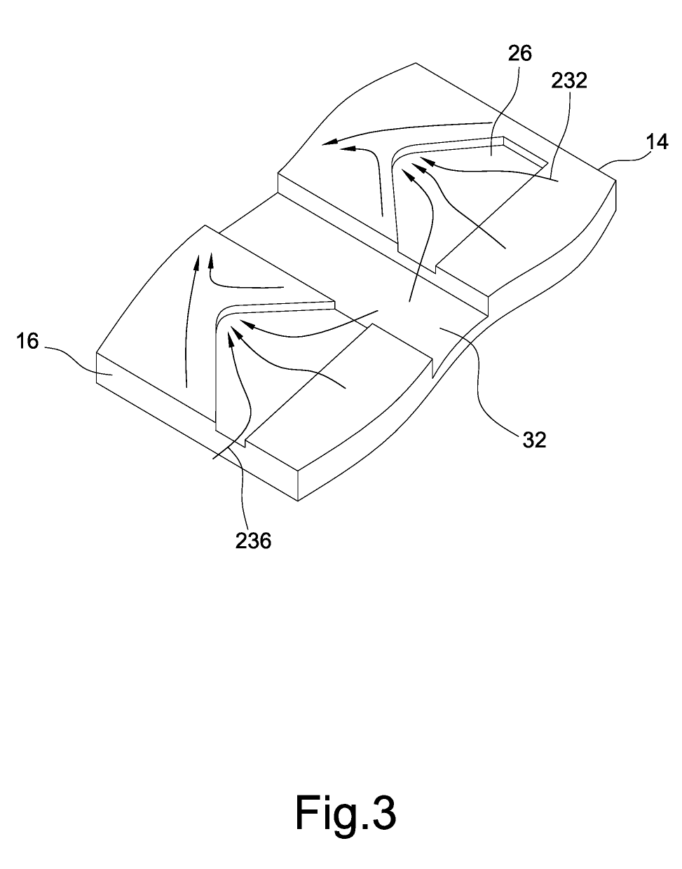

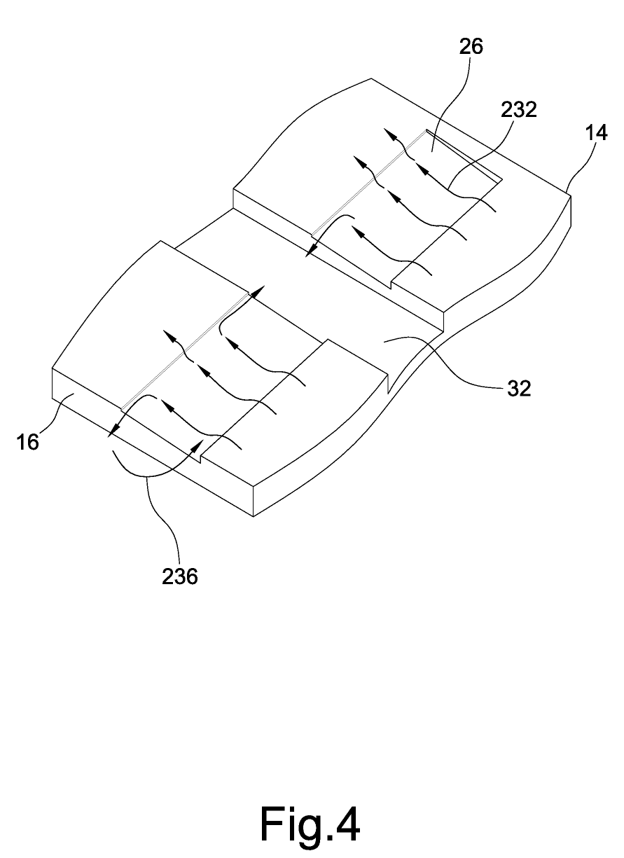

The contact area of linear grooves is enlarged to form plane type grooves 26 which have a far longer unit circular length than its depth as shown in FIGS. 3 and 4, wherein plane shapes of grooves include circular arc shapes, sawtooth shapes or rectangular shapes. The flowing mass and radial pressure of lubricating fluid formed by plane type grooves are generally greater than the ones formed by linear grooves. Plane grooves can be cut on the inner surface of bearing, or the surface of shaft, wherein the best design is to have 5-7 sets of plane grooves at one circle. The groove cutting depths can be uniformed or not uniformed. Groove depths on inner surface of bearing are not uniformed but are cut from deep to shallow along rotating direction. The groove depths on shaft are also not uniformed but are cut from shallow to deep along the axial direction. The tail end of the groove is kept at a distance from the first end face 14 of bearing without connecting to the outside.

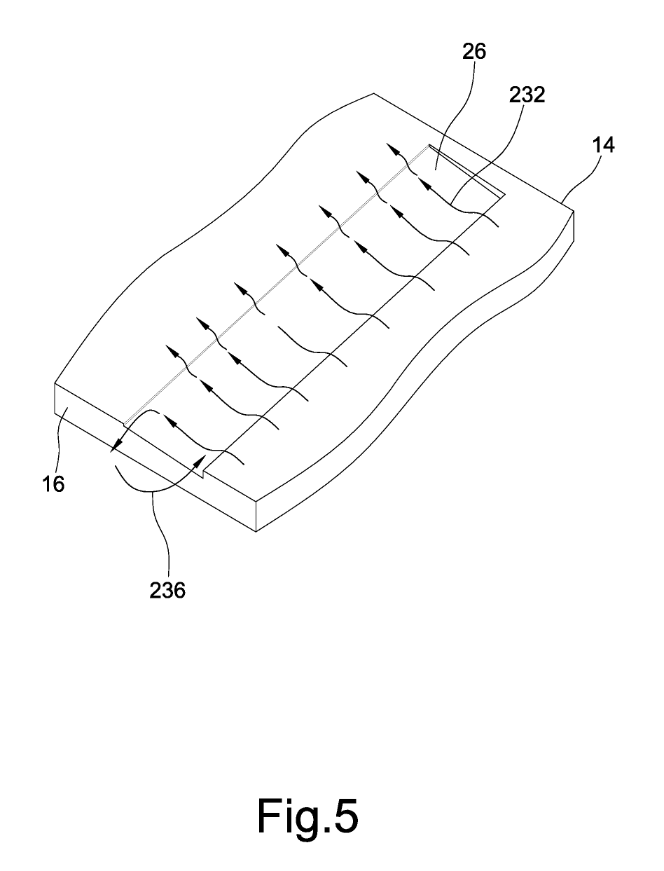

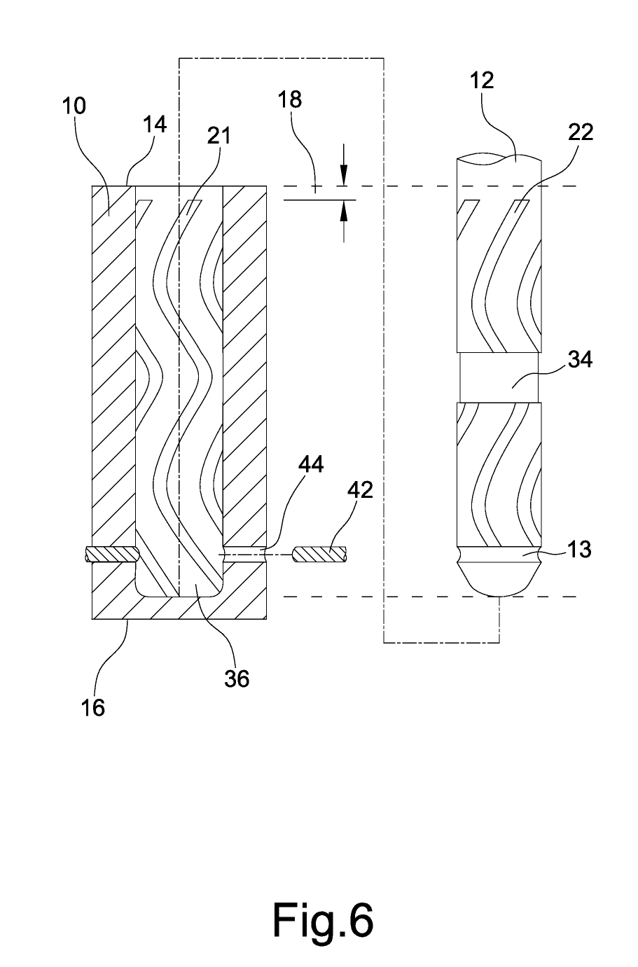

The shapes of linear or plane type grooves can be continuous or intermittently separated as referring to FIGS. 5 and 6.

(2) Open Type grooves

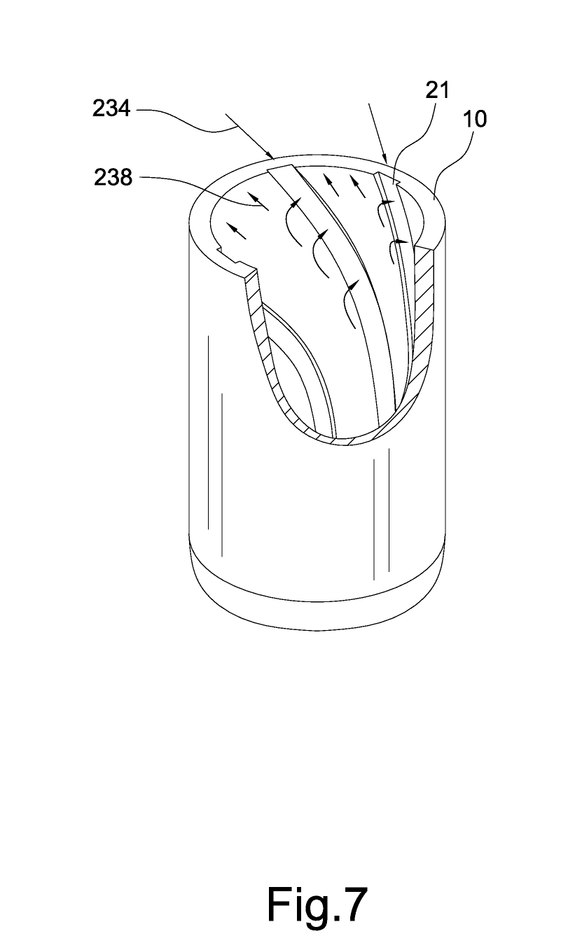

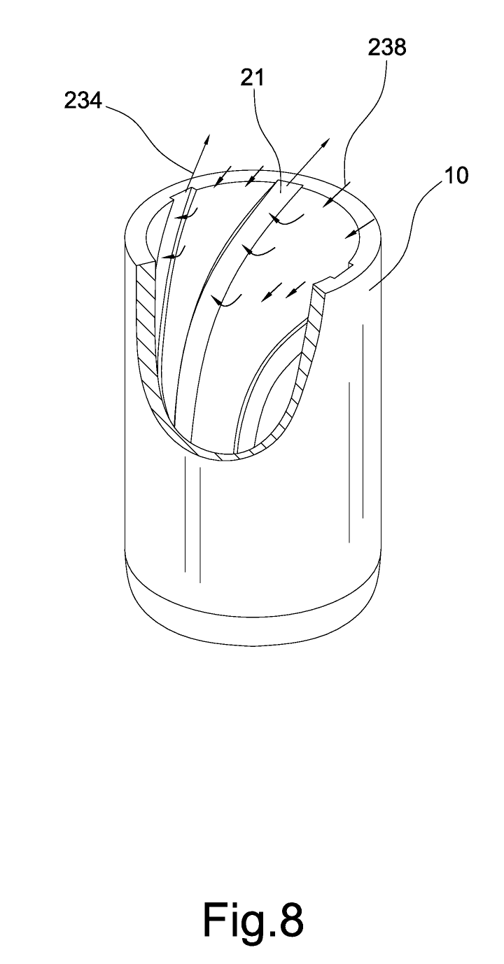

In an open type grooves design, tail end of the groove is connected with the first end face of bearing which is mainly used for gaseous fluid. Referring to FIGS. 7 and 8, a plurality of helical or rifling shaped open type grooves are cut in a circle from first end face to bottom of bearing on the inner surface of bearing, whereby when shaft is rotated, external air is flowed into the bearing through the grooves to form a circular helical flow 234, and when the internal pressure of bearing is increased, the internal heated gas is exhausted out of bearing by the external exchange flow 238, wherein flow in and flow out directions of air flow can be changed by varying rotating angles of rifling lines. Hereby, the open type grooves have the functional advantages of lubrication and temperature cooling.

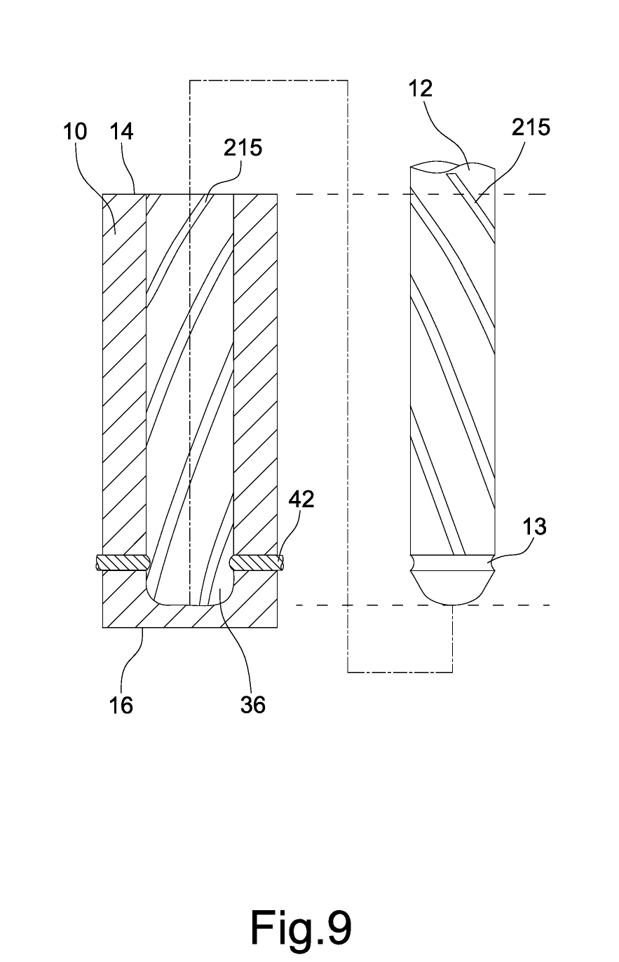

Flow in and flow out directions of circular helical flow 234 and external exchange flow 238 are determined by the cutting directions of helical or rifling lines are relative to the rotating direction of shaft. Further, the open type grooves cutting surface can be inner surface of bearing or surface of shaft or both of them as shown in FIG. 9.

(3) Re-circulating Type grooves

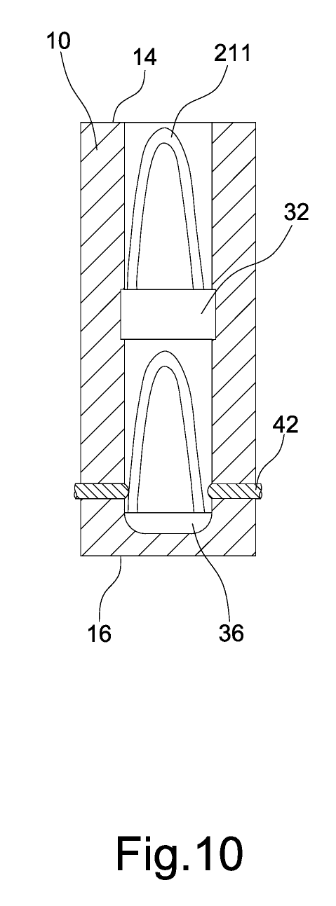

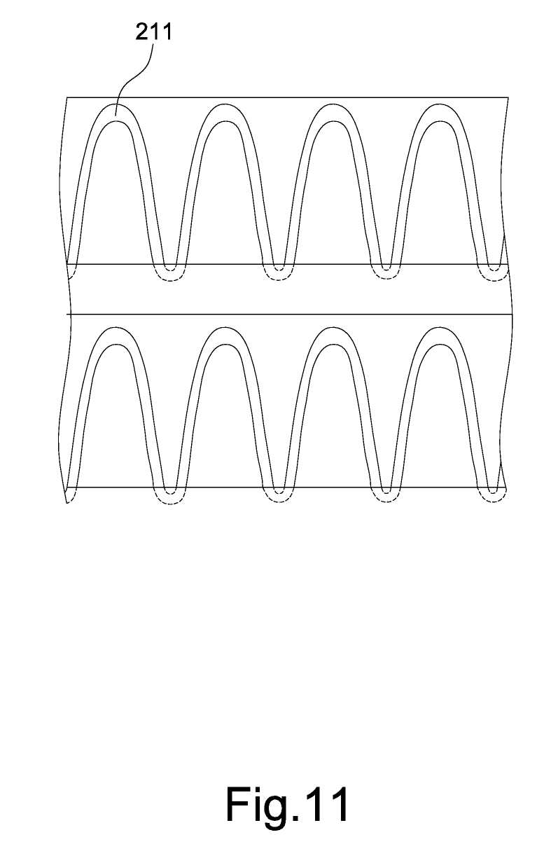

The recirculation type grooves embodiment is mainly applicable for oil grease type liquid lubricants. As shown in FIGS. 10 and 11, the embodiment has concurrent characteristics of both aforesaid groove embodiments, wherein recirculation type grooves 211 are designed to appear recirculation type periodic grooves curves such as sawtooth shapes, or sinusoidal wave shapes, etc. to circle around inner surface of the bearing or surface of the shaft, and the grooves curve recirculation in axial direction shall at least pass one lubricating fluid storing space 32 (or 34) or 36 to bring out of or re-circulate back to the storing space, thereby to constitute a circulation circuit.

The bearing hole shown in FIG. 1 is of penetration type which is convenient to install anti-breakaway lock ring, wherein the the penetration type bearing requires more matching components. The working design for an integrally formed bearing is shown in FIG. 6, bearing bottom 36 is a closed space which can be designed to be a plane, or a circular arc concave or a protruded face, while the top end of shaft 12 can be made to a circular arc shape or a plane shape correspondingly, whereby due to the corresponding shapes between the shaft and the bearing, friction force between them can be reduced. Due to the integral bearing design, to avoid breakaway of bearing from shaft by an external force during the rotating process, a anti-breakaway mechanism shall be installed on the bearing, wherein at least one locking hole 44 or slot is made on the circle of bearing for housing a anti-breakaway lock 42, etc. which can lock into position neck 13 when shaft under external force is ready to break away from the bearing.

I claim:

1. A fluid dynamic bearing comprising at least a bearing and a shaft, wherein a plurality of grooves combining with lubricating fluid storing spaces are made around an inner surface of said bearing or on an external surface of said shaft or on both of them, wherein said groove is a seal, an open or a re-circulation type groove.

2. The fluid dynamic bearing as claimed in claim 1, wherein said inner groove is a seal type groove and edges of a groove curve thereof in maximum height are shorter than one of end faces of said bearing in axial direction, and a lubricating fluid storing space in connection with said edge thereof is kept at a distance from the end face of said bearing.

3. The fluid dynamic bearing as claimed in claim 1, wherein said recirculation type groove includes at least one set of periodic grooves curves in circular direction of sawtooth shapes, or sinusoidal wave shapes, to circle around inner surface of said bearing or surface of said shaft or both of them, and a groove curve recirculation in axial direction is connectable to a lubricating fluid storing space.

4. The fluid dynamic bearing as claimed in claim 1, wherein said open type groove includes more than one set of helical or rifling shaped grooves, and is extended from one end face of bearing to another end face of bearing, wherein the shapes of grooves in axial direction are continuous or intermittently separated.

5. The fluid dynamic bearing as claimed in claim 2, wherein grooves are linear types of sawtooth shapes and circular arc shapes, and the shapes of grooves in axial direction are continuous or intermittently separated.

6. The fluid dynamic bearing as claimed in claim 2, wherein said grooves are plane shapes which are expanded from circular arc shapes, sawtooth shapes or rectangular shapes in circular direction to circular arc plane shapes, sawtooth plane shapes or rectangular plane shapes, wherein depths of said groove are uniformed or the groove depths on inner surface of bearing are made from deep to shallow along the rotating direction while the groove depths on external surface of shaft are made from shallow to deep along the axial direction, and the shapes of grooves are continuous or intermittently separated along the axial direction.

7. The fluid dynamic bearing as claimed in claim 1, wherein said bearing is integrally formed to be a completely penetrated cylinder or the one with a closed bottom.

8. The fluid dynamic bearing as claimed in claim 7, wherein the bearing is integrally formed and more than one locking holes or slots are made at a circle of bearing, and anti-breakaway locks are inserted into locking holes or slots at the inner walls of the bearing.

9. The fluid dynamic bearing as claimed in claim 7, wherein the bearing is integrally formed and said bearing is made of metal or plastic material, or made of both of them.

10. The fluid dynamic bearing as claimed in claim 7, wherein the bearing is integrally formed and a bottom of the bearing is made to a plane, or a circular arc concave or a protruded face with curvature.

11. The fluid dynamic bearing as claimed in claim 1, wherein the inner surface of the bearing and the external surface of the shaft are coated with Molybdenum disulphide or Boron nitride material.

12. The fluid dynamic bearing as claimed in claim 1, wherein said bearing is made of plastic material with Molybdenum disulphide or Boron nitride contents.
